(19) United States
(12) Patent Application Publication
(10) Pub. No.: US 2026/0366690 A1
(43) Pub. Date: Nov. 19, 2026

(54) LIGHTING DEVICE FOR A MOTOR VEHICLE

(71) Applicant: HELLA GMBH & CO. KGAA, Lippstadt (DE)

(72) Inventors: Lukas Langer, Bochum (DE); Wolf Alexander Quitsch, Beckum (DE)

(21) Appl. No.: 19/675,928

(22) Filed: May 13, 2026

(30) Foreign Application Priority Data
May 16, 2025 (DE) 102025118986.2

(51) Int. Cl. F21S 41/68; F21S 41/20

(52) U.S. Cl. CPC F21S 41/68; F21S 41/2805

(57) ABSTRACT

A lighting device for a motor vehicle is provided. The lighting device includes a light source, a first LC display, and a second LC display. At least a portion of light emitted by the light source enters the entry surface of the first LC display and exits the exit surface of the first LC display. The first LC display is controlled to selectively allow portions of the light incident on the entry surface to pass through the first LC display and to prevent other portions from passing through. At least a portion of the light exiting from the first LC display enters the entry surface of the second LC display and exits the second LC display. The second LC display is controlled to selectively allow portions of the light incident on its entry surface to pass through the second LC display and to prevent other portions from passing through.

### CROSS-REFERENCE TO RELATED APPLICATIONS

This application claims priority to German Patent Application 10-2025-118-986.2, filed May 16, 2025, the disclosure of which is incorporated by reference.

### FIELD OF THE INVENTION

The present invention relates to a lighting device for a motor vehicle.

### BACKGROUND OF THE INVENTION

A lighting device of the above-mentioned type is known from WO 2023/025626 A1. The lighting device described therein comprises a lighting module that has at least one light source and a light-emitting surface illuminated by the light source, from which light is emitted during operation of the lighting device, and an LC display that is arranged at least partially in front of the light-emitting surface in such a way that during operation of the lighting device at least one portion of the light emerging from the light-emitting surface enters an entry surface of the LC display and emerges from an exit surface of the LC display, wherein the lighting device is set up such that the LC display is controlled in order to selectively allow portions of the light incident on the entry surface to pass through the LC display and to prevent other portions of the light incident on the entry surface from passing through the LC display.

There are corresponding requirements for lighting devices in the exterior region of a motor vehicle that are intended, for example, to generate signal functions. It has been shown that the required contrast values are generally not achieved when using a single LC display. In principle, it is possible to achieve a higher contrast with one LC display. However, this is at the expense of transmittance, switching time, and switching voltage. In particular, a higher switching voltage can lead to further disadvantages, such as the risk of crosstalk or reduced robustness.

It is also possible to backlight an LC display with switchable segments, but this is very expensive. A further disadvantage is that a lighting device of the type mentioned at the beginning can only be switched between light and dark, whereby no gray levels are possible.

### SUMMARY OF THE INVENTION

The problem underlying the present invention is therefore the creation of a lighting device of the type mentioned at the beginning that can fulfill the requirements for a lighting device in the exterior of an automobile, and yet can be manufactured at a comparatively lower cost. According to the invention, this is achieved by a lighting device of the type mentioned at the beginning with the features set forth herein.

According to one embodiment, it is provided that the lighting device comprises a second LC display having an entry surface and an exit surface, wherein during operation of the lighting device at least one portion of the light emitted from the exit surface of the first LC display enters the entry surface of the second LC display and exits the exit surface of the second LC display, wherein the lighting device is set up such that the second LC display is controlled in order to selectively allow portions of the light incident on the entry surface to pass through the second LC display and to prevent other portions of the light incident on the entry surface from passing through the second LC display. The second display enables the lighting device to meet the requirements for a lighting device in the automotive exterior without incurring high additional costs for segmented backlighting. In particular, the required contrast values can be achieved while still retaining the properties of the individual LC displays. Furthermore, the arrangement of two LC displays, one behind the other, also allows gray levels to be generated. Thanks to the two LC displays arranged in series, shorter switching times can be achieved, and lower switching voltages can be used than in the case of a single LC display with comparable contrast.

It may be provided that each of the two LC displays has a plurality of segments that can be controlled independently of one another, in particular where the segments of the first LC display differ from the segments of the second LC display in terms of their size and/or shape, or wherein the segments of the first LC display correspond to the segments of the second LC display in terms of their size and shape. For example, the segments of one of the two LC displays can have a square or rectangular shape, and the segments of the other of the two LC displays can have a circular or oval shape. Alternatively, it can be provided that both LC displays correspond to each other or have the same design, wherein the segments of both LC displays can also have the same size and shape, so that the LC displays have the same resolution.

It is possible that each of the two LC displays has a liquid crystal layer that is arranged between two mutually opposite, at least partially transparent panes.

It may be provided that only three at least partially transparent panes are provided, wherein the liquid crystal layer of the first LC display is arranged between the first pane and the second pane, and wherein the liquid crystal layer of the second LC display is arranged between the second pane and the third pane, in particular wherein both the exit surface of the first LC display and the entry surface of the second LC display are formed on the second pane. The provision of only three panes results in a compact design of the lighting device.

Alternatively, it may be provided that four at least partially transparent panes are provided, wherein the liquid crystal layer of the first LC display is arranged between the first pane and the second pane, and wherein the liquid crystal layer of the second LC display is arranged between the third pane and the fourth pane, in particular wherein the lighting device comprises a connecting material arranged between the second pane and the third pane. This design can be manufactured more cost-effectively because commercially available LC displays can potentially be connected to each other by means of the connecting component.

It is possible that the connecting material and the connection between the connecting material and the second and the third pane are temperature-resistant in a temperature range between -40°C and 105°C and retain their properties. The connecting material can be selected and dosed in such a way that mechanical stresses in the temperature range from -40°C to 105°C do not damage the lighting device. Furthermore, the connecting material can be robust against moisture, in particular wherein the connecting material can be both robust against hydrolysis and have the lowest possible water vapor permeability. Furthermore, the connecting material can have a service life of at least 15 years. Furthermore, the connecting material can be relatively insensitive to mechanical stresses so that an SAE vibration and shock test can be passed. These properties make the connecting material suitable for use in the exterior region of the motor vehicle.

It may be provided that the lighting device comprises at least one UV protection. UV protection ensures that the liquid crystal layers inside the LC displays are not impaired in their function.

It is possible that the lighting device comprises a cover pane that is designed in such a way that during operation of the lighting device, the light emitted from the exit surface of the second LC display can emerge from the lighting device through the cover pane, in particular wherein the cover lens has the at least one UV protection. The cover lens can therefore prevent light with a wavelength of less than 400 nm from entering the lighting device.

Alternatively or additionally, it may be provided that the connecting material has at least one UV protection. In this case, the connecting material can prevent light with a wavelength of less than 400 nm from passing through the connecting material into the LC displays.

Alternatively or additionally, it may be provided that the at least one UV protection is arranged on at least one of the LC displays, in particular, is laminated onto at least one of the LC displays. For example, a plastic film consisting of triacetate cellulose (TAC) could be laminated onto the LC displays, which can also prevent the penetration of light with a wavelength of less than 400 nm into the LC displays.

It is possible that the lighting device comprises positioning aids for joining the two LC displays, wherein in particular the positioning aids are arranged in a transparent metal oxide layer of the respective LC display. Precise positioning of the two LC displays in relation to each other ensures the desired optical properties. Positioning aids can be arranged in the transparent metal oxide layer, in particular the ITO layer, in regions that are located outside the active surface of the metal oxide layer. This does not impair the function of the LC displays.

It may be provided that each of the LC displays is a passive LC display, in particular wherein each of the LC displays is a smart glass display. For an automotive lighting function, small surfaces are generally used, from which a high light output or a high brightness must be achieved. Therefore, a high transmittance of the LC displays is important in order to generate the legally required luminous intensities of a signal function. In contrast to an active LC display, a passive LC display has no active components such as transistors, so that the transmittance of the passive LC display is significantly higher than that of an active LC display. With a smart glass display, no polarization filters are required, so that a higher transmittance is available, which is advantageous for fulfilling the desired lighting function. Furthermore, the LC display is also independent of the viewing angle due to the elimination of the polarizers.

It is possible that the LC display is an LC display doped with color pigments. In particular, the LC display can in this case be a so-called dye-doped display, which is doped with color pigments that determine the color of the LC display when it is not in operation.

### DESCRIPTION OF THE DRAWINGS

The invention is explained in more detail below with reference to the accompanying drawings. In the drawings:

FIG. 1 is a schematic sectional view of a first embodiment of a lighting device according to the invention;

FIG. 2 is a schematic sectional view of the first LC display of the lighting device according to FIG. 1;

FIG. 3 is a detail of a schematic sectional view of a second embodiment of a lighting device according to the invention; and

FIG. 4 is a schematic sectional view of a third embodiment of a lighting device according to the invention.

In the figures, identical and functionally identical parts are marked with the same reference symbols.

### DETAILED DESCRIPTION OF THE CURRENT EMBODIMENTS

The lighting devices shown in the figures comprise a light source not shown, as well as a first LC display 1 and a second LC display 1′. The first and the second LC displays 1, 1′ are substantially identical and correspond to the first LC display 1 described in detail with reference to FIG. 2.

The LC display 1 shown in FIG. 2 comprises two mutually opposite, at least partially transparent panes 2, 3, between which a liquid crystal layer 4 is arranged. This liquid crystal layer 4 contains only schematically indicated liquid crystals 5 and color pigments 6.

The LC display 1 further comprises a transparent metal oxide layer 7, in particular an ITO layer, on the inner side of each of the panes 2, 3, and an orientation layer 8 between the metal oxide layer 7 and the liquid crystal layer 4. In this case, for example, the outer side of the upper pane 2 in FIG. 2 serves as the entry surface 9 for the light emitted by the light source, whereas the outer side of the lower pane 3 in FIG. 2 serves as the exit surface 10 for the light entering through the entry surface 9.

The LC display 1 further comprises a seal 11 made of an encapsulation adhesive at each end of the liquid crystal layer 4. The LC display 1 further comprises control means 12 shown only schematically, which can be connected to the vehicle’s on-board electronics via a supply line 13.

The LC display 1 is a passive LC display that is designed as a so-called smart glass display. The LC display 1 consists of a plurality of separately switchable segments. These are formed by regions of the metal oxide layer that can be controlled independently of each other.

In an operating state (on-state), the controlled segment of the LC display 1 allows the light that has entered through the part of the entry surface 9 of the controlled segment to exit at least partially, in particular for the most part, from the exit surface 10, whereas in a non-operating state (off-state), the controlled segment of the LC display 1 does not allow the light that has entered through the corresponding part of the entry surface 9 to exit from the exit surface 10.

For the sake of simplicity, the reference symbols of the first LC display 1 are used for the second LC display 1′ and its parts in the drawings, the descriptions of the figures, and the claims in a version provided with a prime.

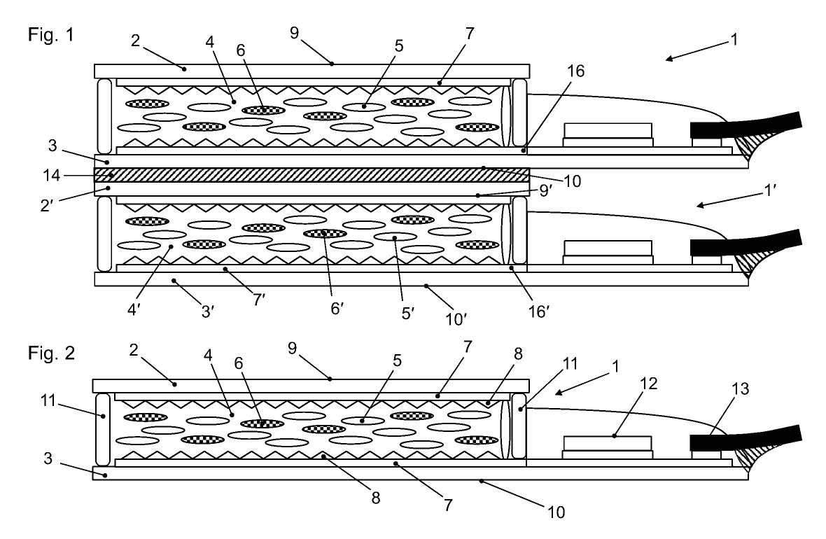

The two LC displays 1, 1′ according to FIG. 1 are arranged in the lighting device such that the light emitted by the at least one light source enters the entry surface 9 of the first LC display 1 and emerges from the exit surface 10 of the first LC display 1 and such that the light emitted from the exit surface 10 of the first LC display 1 enters the entry surface 9′ of the second LC display 1′ and emerges from the exit surface 10′ of the second LC display 1′. The four at least partially transparent panes 2, 3, 2′, 3′ are arranged one behind the other in the direction of propagation of the light emitted by the light source (see FIG. 1).

The embodiment of the lighting device shown in FIG. 1 further comprises a connecting material 14 that is arranged between the first LC display 1 and the second LC display 1′. In particular, the connecting material 14 is in contact with the underside of the second pane 3 and the upper side of the third pane 2′.

The connecting material 14 and the connection between the connecting material 14 and the second and the third pane 3, 2′ are temperature-resistant in a temperature range between - 40°C and 105°C. Furthermore, the connecting material 14 is selected and dosed in such a way that mechanical stresses in the temperature range from -40°C to 105°C do not lead to damage to the lighting device. Furthermore, the connecting material is robust against moisture, in particular wherein the connecting material 14 is both robust against hydrolysis and has the lowest possible water vapor permeability.

It may be provided that the connecting material 14 is impermeable to light with a wavelength of less than 400 nm, so that no UV light can pass through the connecting material 14 into the LC displays 1, 1′. In this case, the connecting material 14 provides UV protection.

It is possible that the lighting device comprises a cover lens, not shown, which is designed in such a way that during operation of the lighting device, the light emitted from the exit surface 10′ of the second LC display 1′ can exit the lighting device through the cover lens. The cover lens can have at least one UV protection and thus prevent light with a wavelength of less than 400 nm from penetrating into the lighting device.

Alternatively or additionally, it may be provided that the at least one UV protection is arranged on at least one of the LC displays 1, 1′, in particular is laminated onto at least one of the LC displays 1, 1′. For example, a plastic film consisting of triacetate cellulose (TAC) could be laminated onto the LC displays 1, 1′, which can also prevent the penetration of light with a wavelength of less than 400 nm into the LC displays 1, 1′.

Precise positioning of the two individual LC displays 1, 1′ relative to each other is required to ensure the optical properties of the lighting device. For the precise positioning of the two individual LC displays 1, 1′, optically detectable markings can be made outside the active surface during assembly. These can be provided, for example, in regions 16, 16′ of the transparent metal oxide layer 7, 7′ that are arranged outside the active surface.

Parallax effects can occur due to the arrangement of LC displays 1, 1′ with identical resolutions, one behind the other. In order to minimize such undesirable effects with LC displays 1, 1′ that are identical in terms of resolution, the optical properties of the connecting material 14 can be adapted to the optical properties of the LC displays 1, 1′. In particular, the refractive index of the connecting material 14 can be adapted to the refractive index of the panes 2, 3, 2′, 3′ of the LC displays 1, 1′. Furthermore, in order to avoid the undesirable effects, the internal panes 3, 2′ could be made thinner than the outer panes 2, 3′.

Furthermore, in order to avoid the undesirable effects, only one pane 3, 2′ can be used in the middle, wherein no connecting material 14 then needs to be provided. One such embodiment is shown in FIG. 4.

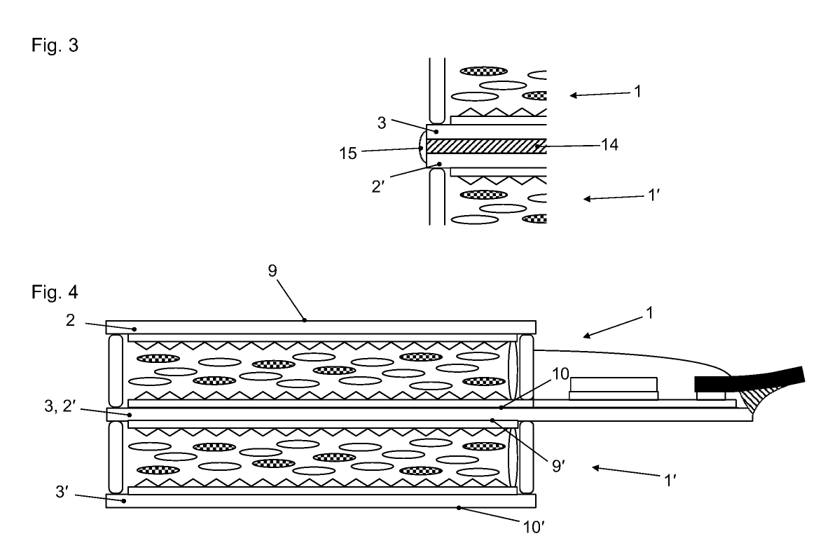

In the embodiment shown in FIG. 3, an additional protection 15 is arranged in the end-side connecting region of the connecting material 14 with the second and third pane 3, 2′.

List of reference signs:
1 first LC display
2, 3 transparent panes of the first LC display
4 liquid crystal layer of the first LC display
5 liquid crystals of the first LC display
6 color pigments of the first LC display
7 metal oxide layer of the first LC display
8 orientation layer of the first LC display
9 entry surface of the first LC display
10 exit surface of the first LC display
11 seal of the liquid crystal layer of the first LC display
12 control means of the first LC display
13 supply line of the first LC display
14 connecting material
15 additional protection of the connecting material
16 region of the metal oxide layer of the first LC display
1′ second LC display
2′, 3′ transparent panes of the second LC display
4′ liquid crystal layer of the second LC display
5′ liquid crystals of the second LC display
6′ color pigments of the second LC display
7′ metal oxide layer of the second LC display
9′ entry surface of the second LC display
10′ exit surface of the second LC display
16′ region of the metal oxide layer of the second LC display

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle configured to be arranged at least partially in an exterior region of the motor vehicle, the lighting device comprising:
at least one light source; and
a first LC display having an entry surface and an exit surface,
wherein at least a portion of light emitted by the at least one light source enters the entry surface of the first LC display and exits from the exit surface of the first LC display during operation,
wherein the lighting device is configured such that the first LC display is controlled to selectively allow portions of the light incident on the entry surface to pass through the first LC display and to prevent other portions from passing through,
wherein the lighting device further comprises a second LC display having an entry surface and an exit surface,
wherein at least a portion of the light exiting from the exit surface of the first LC display enters the entry surface of the second LC display and exits from the exit surface of the second LC display during operation, and
wherein the lighting device is configured such that the second LC display is controlled to selectively allow portions of the light incident on the entry surface of the second LC display to pass through the second LC display and to prevent other portions from passing through.

2. The lighting device of claim 1, wherein each of the first and second LC displays has a plurality of segments that are independently controllable, and wherein segments of the first LC display differ from segments of the second LC display in size or shape, or correspond in size and shape.

3. The lighting device of claim 1, wherein each of the first and second LC displays comprises a liquid crystal layer arranged between two mutually opposite, at least partially transparent panes.

4. The lighting device of claim 3, wherein three at least partially transparent panes are provided, wherein the liquid crystal layer of the first LC display is arranged between a first pane and a second pane, and the liquid crystal layer of the second LC display is arranged between the second pane and a third pane, and wherein the exit surface of the first LC display and the entry surface of the second LC display are formed on the second pane.

5. The lighting device of claim 3, wherein four at least partially transparent panes are provided, wherein the liquid crystal layer of the first LC display is arranged between a first pane and a second pane, and the liquid crystal layer of the second LC display is arranged between a third pane and a fourth pane, and wherein the lighting device further comprises a connecting material arranged between the second pane and the third pane.

6. The lighting device of claim 5, wherein the connecting material and a connection between the connecting material and the second and third panes are temperature-resistant within a temperature range between −40°C and 105°C and retain their properties.

7. The lighting device of claim 5, wherein the connecting material is resistant to moisture.

8. The lighting device of claim 5, wherein the connecting material has a service life of at least 15 years.

9. The lighting device of claim 1, wherein the lighting device comprises at least one UV protection.

10. The lighting device of claim 1, further comprising a cover lens configured such that light emitted from the exit surface of the second LC display exits the lighting device through the cover lens, wherein the cover lens comprises the at least one UV protection.

11. The lighting device of claim 5, wherein the connecting material comprises at least one UV protection.

12. The lighting device of claim 1, wherein the at least one UV protection is arranged on at least one of the LC displays.

13. The lighting device of claim 1, wherein the lighting device comprises positioning aids for joining the first and second LC displays.

14. The lighting device of claim 1, wherein each of the LC displays is a passive LC display.

15. The lighting device of claim 1, wherein each of the LC displays is doped with color pigments.
